(19) United States
(12) Patent Application Publication
(10) Pub. No.: US 2025/0384264 A1
(43) Pub. Date: Dec. 18, 2025

(54) CLASSIFIER GUIDED CLUSTER DENSITY REDUCTION

(71) Applicant: The Toronto-Dominion Bank, Toronto (CA)

(72) Inventors: Cheng Chang, Toronto (CA); Keyu Long, Toronto (CA); Ted Li, Toronto (CA); Himanshu Rai, Toronto (CA); Maksims Volkovs, Toronto (CA)

(73) Assignee: The Toronto-Dominion Bank, Toronto (CA)

(21) Appl. No.: 18/817,329

(22) Filed: Aug. 28, 2024

Related U.S. Application Data
(60) Provisional application No. 63/659,887, filed on Jun. 14, 2024.

(51) Int. Cl. G06N 3/08; G06F 16/215

(52) U.S. Cl. CPC G06N 3/08; G06F 16/215

(57) ABSTRACT

An example operation may include one or more of retrieving an annotated source dataset from a storage via a software application, retrieving a non-annotated target dataset from the storage via the software application, identifying a subset of data from the annotated source dataset, wherein the subset is configured to include source dataset data that is similar to the non-annotated target dataset, reducing the subset of data from the annotated source dataset by using a classifier to remove redundant data from the subset of data from the annotated source dataset, and classifying data from the non-annotated target dataset by a trained artificial intelligence (AI) model.

### BACKGROUND

In the field of supervised machine learning, the performance and accuracy of predictive models are highly dependent on the quality and quantity of annotated data. Acquiring high-quality annotated datasets is often a resource-intensive process, involving substantial time and financial investment for accurate labeling. The challenge is compounded when dealing with diverse and large-scale data sources, which necessitate extensive computational resources and storage capabilities for effective model training. Moreover, the presence of redundant or irrelevant data within these large datasets can further degrade the efficiency and performance of the learning algorithms, leading to longer training times and suboptimal model accuracy. Therefore, there is a critical need for an innovative solution that can efficiently identify and extract a representative subset of data from a large, annotated dataset, ensuring it closely matches the target dataset's characteristics while minimizing redundancy. Such a solution would significantly reduce the computational burden and cost associated with data preparation, enabling more rapid and effective training of machine learning models, and ultimately enhancing the performance and scalability of AI-driven systems.

### SUMMARY

One example embodiment provides an apparatus that includes a memory and a storage communicably coupled to at least one processor, wherein the at least one processor may one or more of retrieve an annotated source dataset from the storage via a software application, retrieve a non-annotated target dataset from the storage via the software application, identify a subset of data from the annotated source dataset, wherein the subset is configured to include source dataset data that is similar to the non-annotated target dataset, reduce the subset of data from the annotated source dataset by using a classifier to remove redundant data from the subset of data from the annotated source dataset; and classify data from the non-annotated target dataset by a trained artificial intelligence (AI) model.

Another example embodiment provides a method that includes one or more of retrieving an annotated source dataset from a storage via a software application, retrieving a non-annotated target dataset from the storage via the software application, identifying a subset of data from the annotated source dataset, wherein the subset is configured to include source dataset data that is similar to the non-annotated target dataset, reducing the subset of data from the annotated source dataset by using a classifier to remove redundant data from the subset of data from the annotated source dataset, and classifying data from the non-annotated target dataset by a trained artificial intelligence (AI) model.

A further example embodiment provides a computer readable storage medium comprising instructions, that when read by a processor, cause the processor to perform one or more of retrieving an annotated source dataset from a storage via a software application, retrieving a non-annotated target dataset from the storage via the software application, identifying a subset of data from the annotated source dataset, wherein the subset is configured to include source dataset data that is similar to the non-annotated target dataset, reducing the subset of data from the annotated source dataset by using a classifier to remove redundant data from the subset of data from the annotated source dataset, and classifying data from the non-annotated target dataset by a trained artificial intelligence (AI) model.

### BRIEF DESCRIPTION OF DRAWINGS

FIG. 1 is a system diagram illustrating an operating environment of a software service according to examples and features of the instant solution.

FIG. 2A is a system diagram illustrating integration of an AI model into a classifier process according to the examples and features of the instant solution.

FIG. 2B is a diagram illustrating a process for developing an AI model that supports AI-assisted Classifier Guided Cluster Density Reduction according to the examples and features of the instant solution.

FIG. 2C is a diagram illustrating a process for utilizing an AI model that supports Classifier Guided Cluster Density Reduction according to examples and features of the instant solution.

FIG. 3 is a system diagram illustrating an operating environment for a product application service that provides Classifier Guided Cluster Density Reduction on annotated data sets, according to examples and features of the instant solution.

FIG. 4A is a diagram illustrating a method of reducing a subset of data by using a classifier to remove redundant data, according to examples and features of the instant solution.

FIG. 4B is another diagram illustrating a method of reducing a subset of data by using a classifier to remove redundant data, according to examples and features of the instant solution.

FIG. 5 is a system diagram illustrating a computing environment according to the instant solution's example features, structures, or characteristics.

### DETAILED DESCRIPTION

The instant solution addresses the aforementioned technical problem by providing a novel approach to dataset selection and reduction, enhancing the efficiency and performance of machine learning model training. The solution involves a multi-stage process that leverages advanced artificial intelligence techniques to systematically identify and extract a representative subset of data from a large, annotated dataset.

Initially, the annotated source dataset and the non-annotated target dataset are retrieved from storage and converted into high-dimensional vectors using Contrastive Language-Image Pre-training (CLIP) and Vision Transformer (ViT) models. These vectors are then ranked for similarity using a CLIP Maximum Mean Discrepancy (CMMD) metric, followed by clustering through k-means clustering on the transformed vectors.

In the subsequent stage, clusters are iteratively selected and ranked based on their similarity to the target dataset, ensuring the subset minimizes redundancy while maintaining diversity. A distribution classifier is employed to further refine this subset, minimizing the divergence between the reduced subset and the original annotated dataset. This refined subset serves as the training set for a classifier model, which is then used to classify the target dataset. The entire process is designed to operate efficiently on various computing environments, including cloud-based and on-premise systems, utilizing different processing units and network configurations.

By reducing the amount of redundant data and focusing on the most relevant subset, the solution significantly decreases the computational resources and time required for training machine learning models. This leads to faster, more accurate model development, thereby improving the overall performance and scalability of AI-driven applications. The instant solution pertains to selecting an optimal dataset from a source pool with annotations to enhance performance on a target dataset derived from a different source. The instant solution is configured to execute on computer systems, hosted compute infrastructure, Central Processing Units (CPU), Graphics Processing Units (GPU), Neural Processing Units (NPU), Tensor Processing Units (TPU), other processing units, embedded computer systems, computer networks, wired and wireless compute devices, physical or virtual compute nodes. More specifically, the instant solution relates to classifier guided cluster density reduction for dataset selection. The instant solution additionally relates to systems and procedures, i.e. programming and configuration, for said classifier guided cluster density reduction.

The instant solution provides Classifier Guided Cluster Density Reduction (CCDR) by combining several techniques in novel way. The CCDR works in stages. In the first stage, source data is embedded into an embedding space, clustered and then ranked based on similarity to target data. In the second stage, clusters selected during the first stage are pruned to ensure diversity while reducing redundant data. In the third stage, the diverse pruned data set is used by a classifier.

The disclosure of the instant solution is expressed using terminology and concepts from Machine Learning (ML), Artificial Intelligence (AI), mathematics, statistics, and computer engineering. Examples include, but are not limited to: Large Language Model (LLM), Natural Language Processing (NLP), transformer, attention, In-Context Learning (ICL), k-Nearest Neighbor (kNN), k-means, gradient boosting, XGBoost, Area Under the receiver operating Characteristic Curve (AUC), Receive Operating Characteristic (ROC), Retrieval-Augmented Generation (RAG), normalization, hyperparameter, Tabular Data, Tabular Prior-Data Fitted Network (TabPFN), Symbolic Automatic INTegrator (SAINT), classifier, classification, classification task, training, annotated data, mean, average, standard deviation, confidence interval, bootstrapping, metric, probability, conditional probability, and probability distribution. These, as well as other similar terms, are well-known to someone with ordinary skills in the art and will be further described when required to illustrate a part of the instant solution.

The term “latent space”, also known as a “latent feature space” or “embedding space”, is an embedding of a set of items within a vector space, or more generally a manifold, in which items resembling each other are positioned closer to one another. The embedding vectors are often referred to as “latents”, “embeddings”, “embedding vectors”, or “vectors”. The terms vector, vector space, and manifold are well known to someone with ordinary skills in the art and will be further described when required to illustrate a part of the instant solution.

The disclosure of the instant solution is expressed using terminology and concepts from computer systems and networking. Examples include, but are not limited to: Central Processing Unit (CPU), Graphics Processing Unit (GPU), Tensor Processing Unit (TPU), Neural Processing Unit (NPU), memory, disk, storage, process, thread, client, server, node, host, virtual machine, stack, kernel, registers, segments, address space, networking, Transmission Control Protocol/Internet Protocol (TCP/IP), cloud, hosted, hosted node, cluster, operating system, containers and container management. These, as well as other similar terms, are well-known to someone with ordinary skills in the art and will be further described when required to illustrate a part of the instant solution.

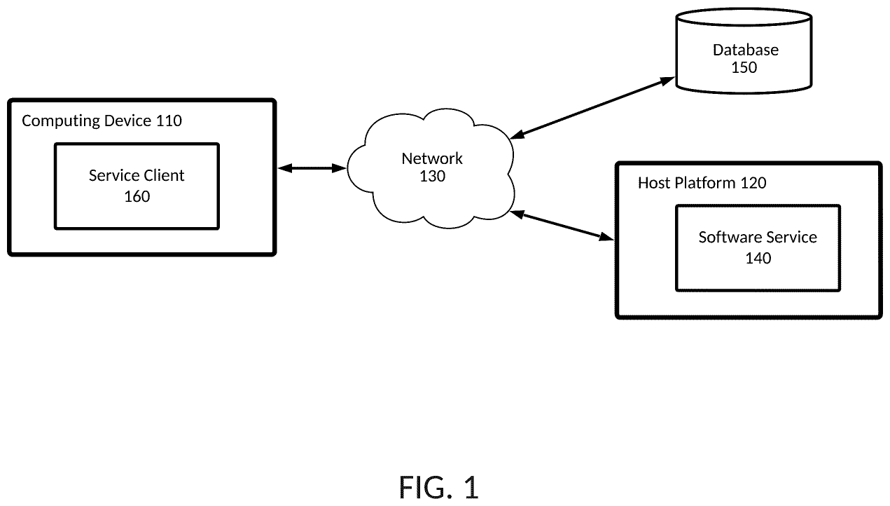

FIG. 1 is a system diagram illustrating an example operating environment 100 of the instant solution. As shown, at least one computing device 110 and a host platform 120 communicate via a network 130. The host platform 120 may host a software service 140. The software service 140 may communicate with one or more databases 150 through a network 130 during the course of service execution. Each computing device 110 may host a service client 160, which communicates with a corresponding software service 140.

A computing device 110 may be a mobile phone, tablet, laptop computer, desktop computer, smartwatch, vehicle infotainment system, or any computing device including a processor and memory. The host platform 120 may include a single physical server, multiple physical servers, a cloud hosting environment, or a hybrid hosting environment in which some components of the host platform 120 are “on-premise” while others are cloud-hosted. The network 130 is a computer network and may include one or more interconnected computer networks. For example, network 130 may be or may include an Ethernet network, an asynchronous transfer mode (ATM) network, a wireless network, a telecommunications network or the like.

The software service 140 provides the service logic. It may provide one or more Application Programming Interfaces (APIs) for communicating with one or more service clients 160. A “thick” user interface client that runs on a computing device 110 may utilize the APIs to communicate with the software service 140. Further, the software service 140 may provide hosted User Interfaces (UIs) that can be accessed through browser-based software on some computing devices 110.

The one or more service clients 160 can enable service access for end users and may come in a variety of forms including, but not limited to, a mobile device application (“app”) or a web portal accessed via a browser on a computing device 110 such as a laptop or desktop computer.

Detailed descriptions of the architecture and operation of the Classifier Guided Cluster Density Reduction service in the instant solution are further described and depicted herein.

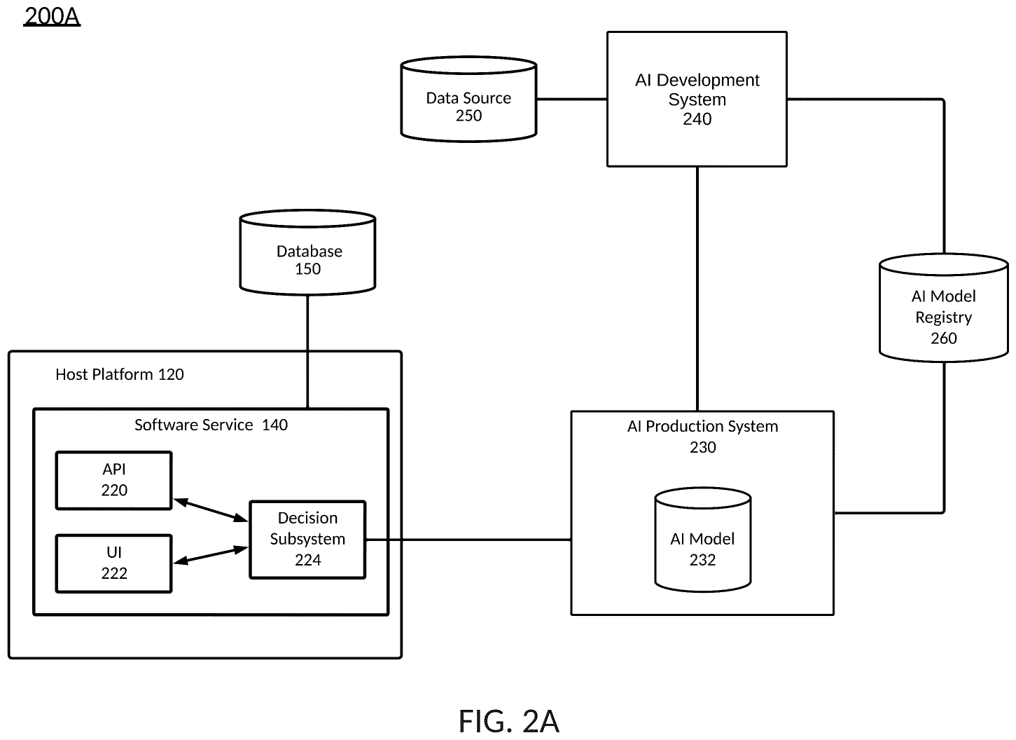

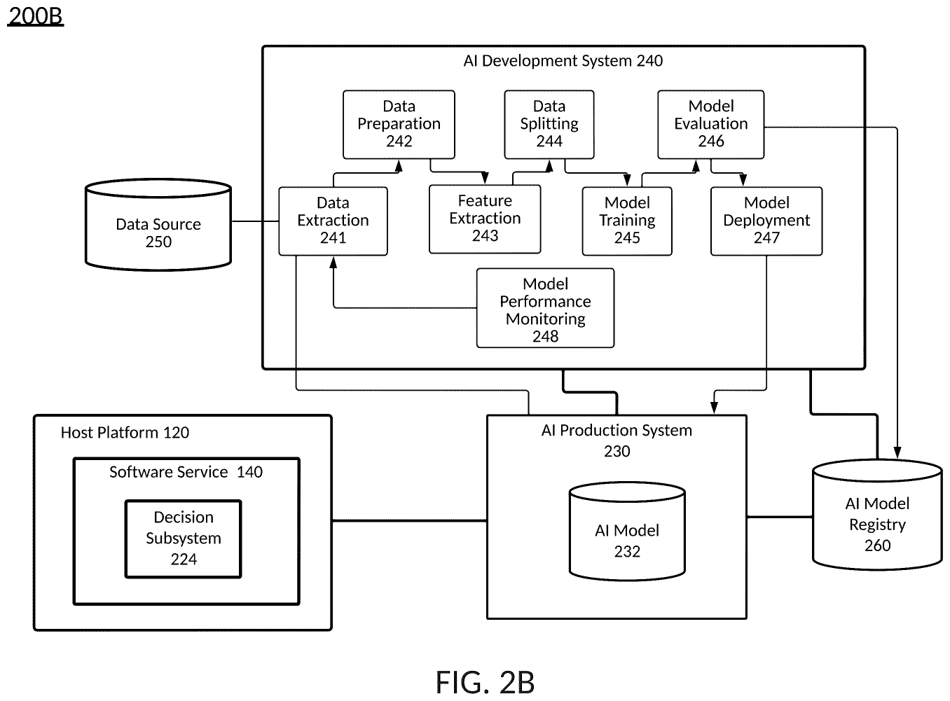

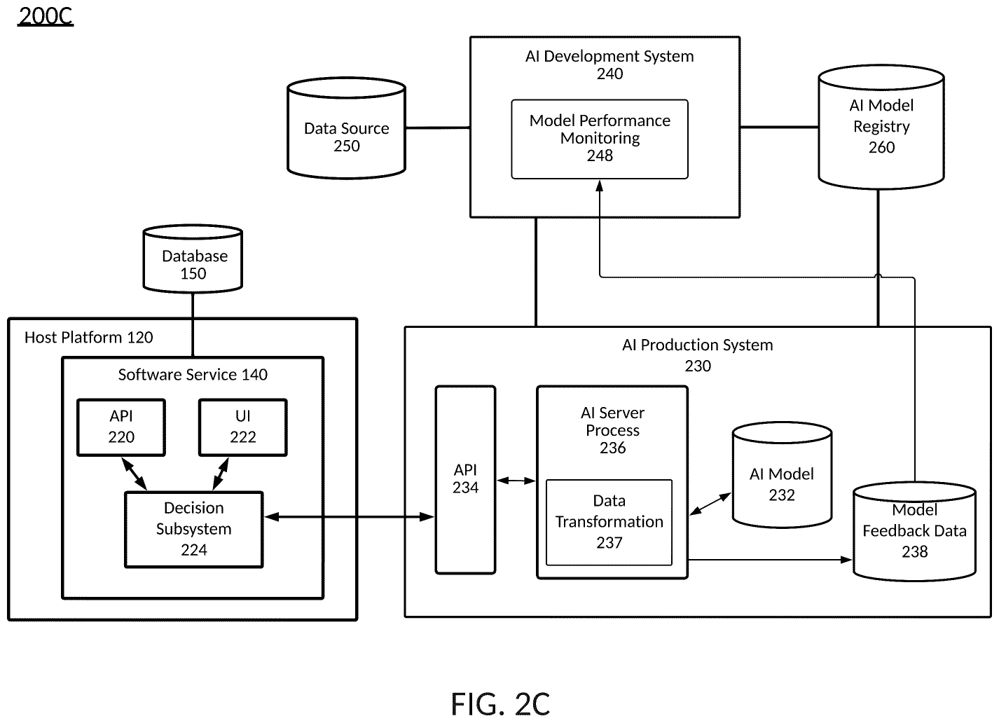

FIG. 2A illustrates an artificial intelligence (AI) network diagram 200A that supports AI-assisted Classifier Guided Cluster Density Reduction in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

Software service 140 (see FIGS. 1, 2A), executing on host platform 120 (see FIGS. 1, 2A) may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 140 to assist in decision-making. In some examples and features of the instant solution, the software service 140 stores data included in API requests or data generated during processing the API requests into one or more databases 150 (see FIGS. 1, 2A).

Software service 140 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 140 to assist with decision-making. In some examples and features of the instant solution, the software service 140 stores data included in UI requests or data generated during processing the UI requests into one or more databases 150.

Software service 140 may include one or more decision subsystems 224 that drive a decision-making process of the software service 140. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 150 to aid in the decision-making process. A decision subsystem 224 may provide feedback to an API 220 or a UI 222.

An AI production system 230 may be used by a decision subsystem 224 in a software service 140 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 140 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 140, UI 222 data from software service 140 or data from other software service 140 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 140. In some examples and features of the instant solution, the response may result in an update to a UI 222 in software service 140. In some examples and features of the instant solution, the response includes a request identifier that can be used later by the software service 140 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

Model retraining involves repeating steps 241-246 using the current data in the data source 250 along with the model feedback data 238. In some examples and features of the instant solution, the AI model 232 is retrained periodically as a matter business process in order to consider the latest data and/or retrained based on a trigger, such as, but not limited to a recent model accuracy falling below a pre-determined threshold. In some examples and features of the instant solution, the model feedback data 238 is used as an input to determine the recent model accuracy.

In some examples and features of the instant solution, the AI production system 230 includes a user interface (not shown). The user interface may be used to manage the production system infrastructure, the components of the production system 230-238, and the operation of the AI production system and its components.

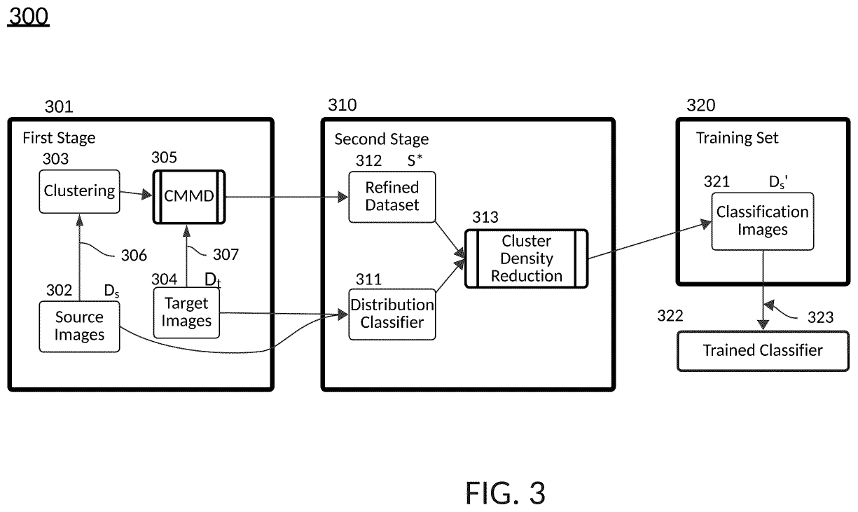

FIG. 3 is a system diagram illustrating an operating environment 300 for a system that provides Classifier Guided Cluster Density Reduction (CCDR) on datasets. The instant solution provides CCDR by combining several techniques in stages. The instant solution starts with a source pool of annotated source images Dₛ 302 and is configured to identify a representative subset of images that can be used in lieu of Dₛ for increased performance.

In some examples and features of the instant solution, the first stage 301 source data or source images Dₛ 302 is embedded into a latent space 306, clustering 303 and ranked based on similarity to the latents 307 from the target images Dₜ 304. The source images Dₛ 302 and target images Dₜ 304 may be loaded in any order but must be both available. A similarity-ranking is performed using Contrastive Language-Image Pre-training (CLIP) Maximum Mean Discrepancy (CMMD) 305 and Vision Transformer (ViT) latents 307 from the target images Dₜ 304.

In some examples and features of the instant solution, the clustering 303 is identified by a k-means clustering on the ViT latents 307, where k-means is the well-known clustering technique that partitions the images into k clusters based on proximity to the center value of each cluster.

In some examples and features of the instant solution, the clustering 303 is then in a second stage 310 ranked in ascending order of their CMMD scores, with the lowest score indicating the closest resemblance to the set of target images Dₜ 304. Images from all ranked clusters are iteratively selected until a subset of images (“refined dataset” S* 312) have been identified that minimize the CMMD score.

In some examples and features of the instant solution, a distribution classifier 311 is trained to pick samples that share the most similarities from the set of target images Dₜ 304, enabling it to fetch the most aligned annotated samples from source images Dₛ 302. See the provisional application's equations (3), (4), and (5) for the inner workings of the distribution classifier 311.

In some examples and features of the instant solution, the distribution classifier

311 is combined in cluster density reduction 313 with a similarity graph comprising latent vectors from the refined dataset S* 312 to create a final set of classification image latents Dₛ′ 321. The distribution classifier 311 is configured to create a Dₛ′ that minimizes divergence between Dₛ′ and the annotated source images Dₛ 302. The classification images Dₛ′ 321 are used as the training set 320 to create 323 a trained classifier 322 for the target images Dₜ 304.

In some examples and features of the instant solution, the operating environment 300 may be an example of an AI development system 240 as described and depicted in FIGS. 2A-2C. In some examples and features of the instant solution, source images Dₛ 302, target images Dₜ 304, latent space 306, latents 307, refined dataset S* 312, training set 320, and classification images Dₛ′ 321 may be retrieved from and/or may be stored in one or more data sources 250, as described and depicted in FIGS. 2A-2C. In some examples and features of the instant solution, first stage 301, second stage 310, clustering 303, CMMD 305, and cluster density reduction 313 may include data extraction 241, data preparation 242, feature extraction 243, data splitting 244, model training 245, model evaluation 246, model deployment 247, and/or model performance monitoring 248, as described and depicted in FIGS. 2A-2C. In some examples and features of the instant solution, the distribution classifier 311 and trained classifier 322 may be examples of AI model 232, as described and depicted in FIGS. 2A-2C.

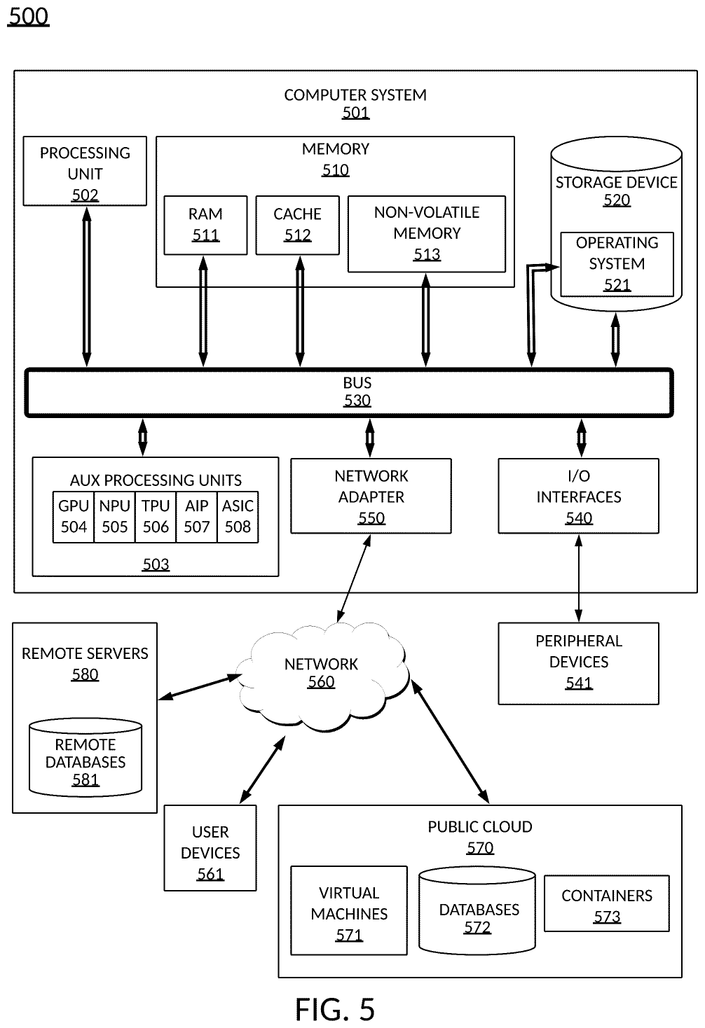

One practical application of the instant solution is classifying data from a non-annotated target dataset, for example 304, by a trained artificial intelligence (AI) model, for example 322, to make classification predictions on the target images, for example 304, based on a reduced set of source images, for example 321, resulting in a more efficient and less resource-intensive classification process, as described and depicted in FIG. 3 and herein. The more efficient and less resource-intensive classification process may reduce utilization of one or more computational resources, including utilization of at least a processing unit, for example FIG. 5 502, an auxiliary processing unit, for example FIG. 5 503, a memory, for example FIG. 5 510, a memory on an auxiliary processing unit, for example, FIG. 5 503, and a storage, for example FIG. 5 520.

Another practical application of the instant solution is identifying a subset of data from an annotated source dataset, for example 302, that resemble data in a target dataset, for example 304, and using the identified subset, for example 321, of data in lieu of the full annotated source dataset to reduce source dataset redundancy, as described and depicted in FIG. 3 and herein.

Another practical application of the instant solution is reducing training resources for a classifier model, for example 322, by training the classifier model on a reduced and representative subset, for example 321, of annotated source data, for example 302, as described and depicted in FIG. 3 and herein.

The previous disclosures are generally expressed in terms of “images”. The instant solution, however, can be expressed for any data type, including but not limited to video, audio, financial data, and other structured numerical data. The instant solution generally applies to annotated data types, distribution classifiers, and the creation of a reduced but closely aligned dataset used for training a classifier model based on a larger annotated set of source data.

The previous disclosures are expressed using the term “latent”. As latents are simply vectors, the instant solution may similarly be expressed using vector terminology without any loss of generality.

The instant solution provides a tangible technical improvement in the field of machine learning by integrating sophisticated algorithms, such as CLIP and ViT, to transform and process large datasets. These algorithms are designed to convert annotated source data and non-annotated target data into high-dimensional vectors, which are then analyzed for similarity using the CMMD metric, ensuring a precise and efficient identification of relevant data subsets, directly addressing the challenges of data redundancy and computational inefficiency that are prevalent in conventional machine learning practices.

The instant solution offers a multi-stage clustering process to enhance data selection and refinement. By employing k-means clustering on the transformed data vectors, the solution effectively partitions the data into meaningful clusters based on similarity metrics. This clustering stage is followed by an iterative selection process that ranks the clusters according to their resemblance to the target dataset, ensuring that the final subset of data is both diverse and representative. This method not only reduces the volume of data required for training but also enhances the quality of the training set, leading to more accurate and efficient model training.

The invention also incorporates a distribution classifier to further refine the selected data subset, minimizing divergence from the annotated source dataset. This classifier is specifically designed to evaluate and prune the data, ensuring that the final training set maintains a high level of relevance and utility for the target application. By focusing on the technical details of the classifier's operation, including its integration with the similarity graph and clustering processes, the invention demonstrates a concrete and practical application of advanced machine learning techniques to solve a technical problem.

In another example of the instant solution, algorithms such as CLIP and ViT are employed. Initially, the annotated source dataset and the non-annotated target dataset are retrieved from storage via a software application. The data is then preprocessed to ensure compatibility with the CLIP and ViT models. For the CLIP model, the textual and visual components of the data are embedded into a shared latent space, enabling the model to learn a joint representation of images and their associated text descriptions. This is achieved by training the model on a large corpus of paired text-image data, optimizing it to predict the correct text description for a given image and vice versa. Similarly, the VIT model, which leverages the transformer architecture, processes the images by dividing them into patches and encoding these patches into high-dimensional vectors. The Vision Transformer then applies self-attention mechanisms to capture the relationships between different parts of the image, producing a comprehensive vector representation for each image. Once the data is converted into these high-dimensional vectors, the CMMD metric is applied to analyze and measure the similarity between the vectors from the source and target datasets. This process ensures that the selected data subset is highly representative of the target dataset, facilitating efficient and accurate model training.

To implement the technical details of the classifier's operation and its integration with the similarity graph and clustering processes, the instant solution employs a structured multi-stage approach. Initially, the annotated source dataset and the non-annotated target dataset are converted into high-dimensional vectors using the CLIP and ViT models. These vectors are then analyzed for similarity using the CMMD metric. The next step involves k-means clustering on the transformed vectors, which partitions the data into clusters based on their similarity scores.

Once the clusters are formed, the system ranks them in ascending order of their CMMD scores, with the lowest scores indicating the closest resemblance to the target dataset. An iterative selection process is then employed to choose images from these ranked clusters, creating a refined subset of data that minimizes redundancy while maintaining diversity. At this stage, a distribution classifier is introduced to further refine the selected data subset. This classifier is trained to evaluate the similarity graph, which is composed of latent vectors from the refined dataset, and to prune the data by removing redundant or less relevant samples.

The integration of the distribution classifier with the similarity graph involves leveraging the relationships and distances between the vectors to ensure that the final training set closely aligns with the target dataset's characteristics. The classifier utilizes this graph to make informed decisions about which data points to retain, thereby optimizing the dataset for training purposes. This refined subset, now devoid of unnecessary redundancy, is used to train the machine learning model.

In one example of the instant solution, a sequence of operations is executed for the effective implementation of the classifier guided cluster density reduction. An annotated source dataset and a non-annotated target dataset are received from storage via a software application. The annotated source dataset includes labeled data, whereas the non-annotated target dataset includes unlabeled data without classification.

Upon retrieving the datasets, a subset of data is identified from the annotated source dataset that exhibits similarity to the data in the non-annotated target dataset. This identification process ensures that the selected subset is representative of the target data, thereby enhancing the relevance and accuracy of the subsequent classification. The software application accesses storage to retrieve both the annotated source dataset and the non-annotated target dataset. The annotated source dataset includes data points that are already labeled, providing a reference for training.

The non-annotated target dataset contains data points that lack labels and classification. To achieve this, the datasets are converted into a plurality of vectors. This conversion involves the execution of advanced machine learning techniques such as CLIP and ViT models on the annotated source dataset and the non-annotated target dataset. These techniques transform the data into a latent space where similar items are positioned closer together, facilitating the identification of similar data points between the two datasets.

Following the vector conversion, the processor ranks the data in the annotated source dataset based on its similarity to the data in the non-annotated target dataset. The ranking process may utilize the CMMD technique, which assesses the similarity between the vectors derived from the annotated and target datasets. The ranking ensures that the most relevant data from the annotated source dataset is prioritized. An identification of the similar subsets is achieved by converting both datasets into vectors using machine learning models that embed the data points into a latent space where similar items are positioned closer together, making it easier to identify which parts of the source dataset are most relevant to the target dataset. The annotated source dataset may be clustered using k-means clustering on the embedded vectors. K-means clustering groups similar data points together, facilitating the management and reduction of the dataset. The reduction functionality employs a similarity graph and a distribution classifier to ensure that the retained data points are diverse and non-redundant.

Subsequently, the annotated source dataset is clustered using k-means clustering on the CLIP and ViT vectors. This clustering groups similar data points together, making it easier to manage and reduce the dataset efficiently. The clusters are then evaluated, and a subset of data is selected based on the similarity rankings obtained earlier.

In the reduction phase, a classifier is employed to remove redundant data from the identified subset of the annotated source dataset. The classifier uses a combination of a similarity graph and a distribution classifier to prune the dataset, ensuring that the most diverse and non-redundant data points are retained. This process minimizes redundancy and enhances the diversity of the dataset, which is used for robust model training.

Finally, the reduced subset of the annotated source dataset is used to train an AI model. The trained AI model is then employed to classify the data in the non-annotated target dataset. The classification process leverages the optimized and reduced dataset, leading to more efficient and accurate predictions.

In one example of the instant solution, when the data is converted into vectors, a subset of the annotated source dataset is identified that is similar to the non-annotated target dataset. This subset undergoes a reduction process to eliminate redundant data points, ensuring that the remaining data is both diverse and representative. The reduction is performed using a combination of a similarity graph and a distribution classifier. The similarity graph represents the relationships and proximities between data points in the latent space, allowing the system to visualize and identify clusters of similar data points.

The distribution classifier further refines this subset by minimizing divergence within the data. It ensures that the selected data points maintain a representative distribution of the original dataset while eliminating redundancy. This classifier evaluates each data point's relevance and uniqueness within the context of the subset, selectively removing those that do not contribute to the overall diversity and representativeness.

The combined use of a similarity graph and a distribution classifier ensures that the reduced subset is optimized for diversity and quality. This reduction process creates a high-quality training dataset that enhances the efficiency and effectiveness of subsequent machine learning tasks, such as classification.

In another example of the instant solution, a distribution classifier is utilized that is configured to minimize divergence between the data in the reduced subset of the annotated source dataset and the original annotated source dataset. The system, equipped with a memory and at least one processor, first retrieves both the annotated source dataset and the non-annotated target dataset from storage via a software application. The processor then converts these datasets into vectors using machine learning models like CLIP and ViT, which embed the data into a latent space to create dense vector representations.

After the conversion, a subset of data is identified from the annotated source dataset that is similar to the non-annotated target dataset. This subset is then reduced to eliminate redundancy while maintaining a representative distribution of the original dataset. The reduction process is guided by a distribution classifier specifically designed to minimize divergence. The distribution classifier evaluates the statistical properties of the reduced subset in comparison to the original annotated source dataset, ensuring that the reduced subset retains the characteristics and diversity of the original dataset.

In another example of the instant solution, an AI model is trained with neural network capabilities. The training process involves feeding the reduced subset into a neural network, which includes layers of interconnected nodes that learn to identify patterns and relationships within the data. The training process is iterative, with the neural network adjusting its weights and biases based on the input data to minimize error and increase accuracy.

During training, the neural network leverages the reduced subset's diverse and representative data points to learn effectively. The training process may involve several stages, including initial training, validation, and tuning, to ensure the model's robustness and performance. Techniques such as backpropagation and gradient descent are used to optimize the neural network's parameters.

The trained AI model is then capable of classifying data from the non-annotated target dataset. The training incorporates various components, such as a distribution classifier, a similarity graph, and clusters of source and target images.

In another example of the instant solution, semi-supervised learning techniques are employed to utilize both labeled and unlabeled data. The annotated source dataset and the non-annotated target dataset are retrieved, converting them into vectors using CLIP and ViT models. The system then applies a semi-supervised learning algorithm that combines the labeled data from the annotated source dataset with the unlabeled data from the target dataset. By leveraging the structure and patterns in the unlabeled data, the functionality refines the model's learning process, resulting in increased performance and generalization on the non-annotated target dataset.

Using both labeled and unlabeled data refines the model's learning process and enhances performance on the non-annotated target dataset. Both datasets are converted into vectors using CLIP and ViT models. CLIP generates dense vector representations by embedding the data into a latent space, while ViT processes image data by segmenting it into patches and using transformer layers to create high-dimensional vectors capturing detailed visual information. The labeled data is used from the annotated source dataset to initially train a base model, feeding the vectorized labeled data into a neural network and adjusting weights and biases through backpropagation and gradient descent to minimize error and increase accuracy. The initially trained base model is applied to the non-annotated target dataset to generate pseudo-labels, which are the model's predicted labels for the unlabeled data points. These pseudo-labels provide an initial classification that approximates true labels.

Subsequently, the labeled data from the annotated source dataset is combined with the pseudo-labeled data from the target dataset, creating an augmented dataset containing both true labels and pseudo-labels. This combined dataset is used to refine the model through semi-supervised learning techniques, including consistency regularization and self-training. Consistency regularization ensures that the model produces expected predictions for the same data points under different augmentations or perturbations, enhancing robustness. Self-training involves iteratively re-training the model using the combined dataset, refining its ability to generalize to new data points. The quality of the pseudo-labels is monitored by evaluating the confidence scores of the model's predictions, giving more weight to high-confidence data points in the training process. Low-confidence predictions may be revisited in subsequent iterations to increase accuracy.

The refined model, now trained on a robust and augmented dataset, undergoes final training to ensure effective learning from the combined data, resulting in increased performance and generalization. The fully trained AI model is then deployed to classify new data points in the non-annotated target dataset, leveraging its learning from the semi-supervised training process to make accurate predictions.

In another example of the instant solution, the system enhances the training dataset by generating synthetic data. The annotated source dataset and the non-annotated target dataset is retrieved and converts them into vectors using CLIP and ViT models. The system then employs data augmentation techniques, such as transformations, rotations, and scaling, to create variations of the existing data points. Additionally, the system may utilize generative adversarial networks (GANs) to generate synthetic data that closely resembles the annotated source dataset. This augmented and synthetic data is combined with the original dataset to train the AI model, resulting in increased robustness and performance.

In the current example, the system retrieves both the annotated source dataset and the non-annotated target dataset from storage. These datasets are converted into vectors using advanced machine learning models, such as CLIP and ViT, embedding the data into a latent space and creating dense vector representations.

When the data is converted into vectors, data augmentation techniques are applied to the annotated source dataset involving the creation of variations of the existing data points through transformations such as rotations, scaling, flipping, and adding noise. These augmentations help to increase the diversity of the dataset without additional labeled data, allowing the model to generalize by learning from a wider range of variations.

In addition to data augmentation, the system employs generative adversarial networks (GANs) to generate synthetic data. The GANs may include two neural networks—the generator and the discriminator—that are trained together. The generator creates synthetic data points that resemble the annotated source dataset, while the discriminator evaluates the authenticity of these data points. Through iterative training, the generator refines its ability to produce realistic synthetic data that closely mimics the characteristics of the original annotated dataset.

This synthetic data is integrated with the augmented data from the annotated source dataset, forming an enriched training dataset. This combined dataset includes both the original labeled data, the augmented variations, and the newly generated synthetic data, significantly increasing the size and diversity of the training data.

This enriched dataset is used to train an AI model. The neural network within the AI model leverages the diverse data points to learn more robust and comprehensive patterns, increasing its accuracy and performance. The training process involves standard techniques such as backpropagation and gradient descent, optimizing the model's weights and biases based on the enriched dataset. The trained AI model is deployed to classify data in the non-annotated target dataset. The model's training on a more diverse and comprehensive dataset enhances its ability to accurately classify new data points, demonstrating increased generalization and robustness.

In one example of the instant solution, the system trains an AI model using neural network capabilities. This training is based on target samples of a target model and source samples, aiming to distinguish between the target samples and the source samples based on global features in the target samples. The neural network adjusts its parameters through backpropagation and gradient descent to learn these distinguishing features effectively.

A neural network includes layers of interconnected nodes or neurons, each with associated weights and biases, which are the parameters adjusted during training. In a forward pass, input data is fed through the network, where each layer performs a linear transformation (multiplying inputs by weights and adding biases) followed by a non-linear activation function (like ReLU or Sigmoid) to introduce non-linearity, allowing the network to learn complex patterns. The output from the network is then compared to the actual labels using a loss function, which quantifies the error between the predicted and true values. Backpropagation is used to compute the gradient of the loss function with respect to each weight and bias by applying the chain rule of calculus, propagating the error backward from the output layer to the input layer. These gradients indicate how much each parameter contributed to the total error. In gradient descent, an optimization algorithm, updates the weights and biases by subtracting a fraction of the gradient (determined by the learning rate) from their current values, iteratively minimizing the loss. Through multiple iterations of forward passes, loss calculations, backpropagation, and gradient descent, the neural network gradually adjusts its parameters to reduce the error, thereby learning the distinguishing features that effectively differentiate between the target and source samples.

A set of source data is received that comprise a plurality of source samples via a software application. This data is retrieved from storage and converts the source samples into a plurality of vectors using advanced machine learning models like CLIP and ViT. These models embed the data into a latent space, generating dense vector representations that capture features and semantics.

These vectors are clustered into a plurality of clusters using techniques such as k-means clustering. This clustering groups similar vectors together, organizing the data into meaningful clusters based on their proximity in the latent space. From these clusters, the processor selects a subset of vectors based on the distribution of vectors within the clusters, ensuring a diverse and representative sample.

When the subset of vectors is selected, the trained classifier AI model is executed on this subset to prune it further into a smaller subset of vectors. The classifier evaluates each vector's relevance and uniqueness, removing redundant or less informative vectors, thus refining the subset to enhance the quality and efficiency of the training data.

The target model is trained based on the smaller, pruned subset of vectors. This training involves feeding the refined subset into the neural network of the target model, allowing it to learn and generalize from the high-quality data. The resulting trained target model benefits from the optimized training process, demonstrating increased performance and accuracy.

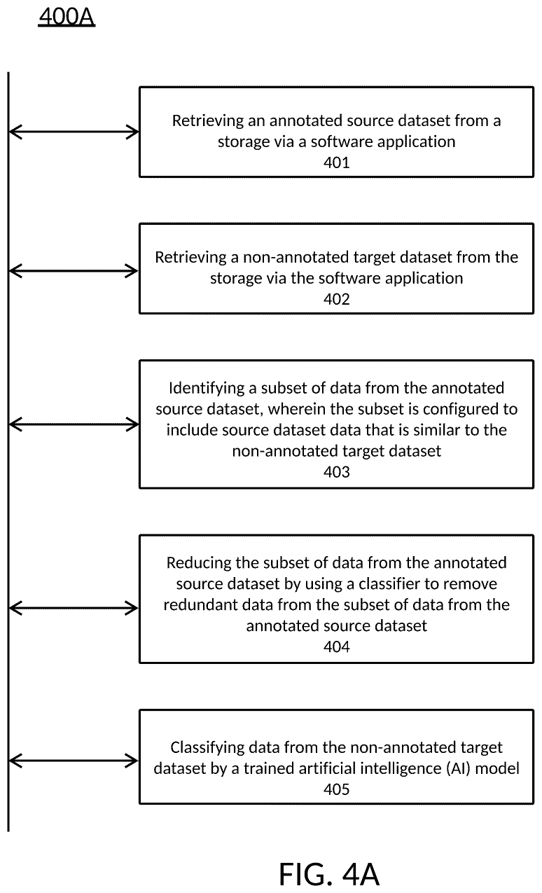

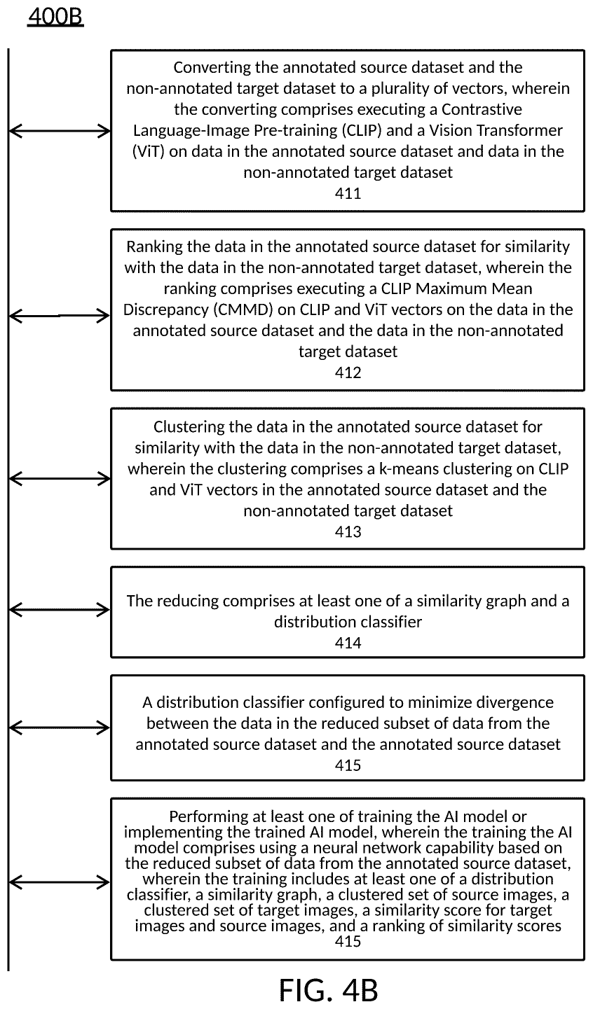

FIG. 4A is a diagram illustrating a method 400A of reducing a subset of data by using a classifier to remove redundant data, according to examples and features of the instant solution. For example, the method 400A may be performed by at least one processor of a host platform such as a cloud platform, a web server, a software application, a combination of systems, and the like. Referring to FIG. 4A, in 401, the method may include retrieving an annotated source dataset from a storage via a software application. In 402, the method may include retrieving a non-annotated target dataset from the storage via the software application. In 403, the method may include identifying a subset of data from the annotated source dataset, wherein the subset is configured to include source dataset data that is similar to the non-annotated target dataset. In 404, the method may include reducing the subset of data from the annotated source dataset by using a classifier to remove redundant data from the subset of data from the annotated source dataset. In 405, the method may include classifying data from the non-annotated target dataset by a trained artificial intelligence (AI) model.

FIG. 4B is another diagram illustrating a method 400B of reducing a subset of data by using a classifier to remove redundant data, according to examples and features of the instant solution. For example, the method 400B may be performed by at least one processor of a host platform such as a cloud platform, a web server, a software application, a combination of systems, and the like. Referring to FIG. 4B, in 411, the method may include converting the annotated source dataset and the non-annotated target dataset to a plurality of vectors, wherein the converting comprises executing a Contrastive Language-Image Pre-training (CLIP) and a Vision Transformer (ViT) on data in the annotated source dataset and data in the non-annotated target dataset. In 412, the method may include ranking the data in the annotated source dataset for similarity with the data in the non-annotated target dataset, wherein the ranking comprises executing a CLIP Maximum Mean Discrepancy (CMMD) on CLIP and ViT vectors on the data in the annotated source dataset and the data in the non-annotated target dataset. In 413, the method may include clustering the data in the annotated source dataset for similarity with the data in the non-annotated target dataset, wherein the clustering comprises a k-means clustering on CLIP and ViT vectors in the annotated source dataset and the non-annotated target dataset. In 414, the method may include the reducing comprises at least one of a similarity graph and a distribution classifier. In 415, the method may include a distribution classifier configured to minimize divergence between the data in the reduced subset of data from the annotated source dataset and the annotated source dataset. In 416, the method may include performing at least one of training the AI model or implementing the trained AI model, wherein the training the AI model comprises using a neural network capability based on the reduced subset of data from the annotated source dataset, wherein the training includes at least one of a distribution classifier, a similarity graph, a clustered set of source images, a clustered set of target images, a similarity score for target images and source images, and a ranking of similarity scores.

The examples and features of the instant solution may be implemented in one or more of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

The Auxiliary Processing Units (APU) 503 may contain one or more Graphics Processing Units (GPU) 504, Neural Processing Units (NPU) 505, Tensor Processing Units (TPU) 506, AI Processor (AIP) 507, or other Application Specific Integrated Circuit (ASIC) 508. Each of the APUs 503 may contain circuitry distributed over multiple integrated circuit chips. Each APU 503 may implement multiple processor threads and multiple processor cores. Each APU 503 may include one or more of onboard memory, onboard memory cache, and onboard instruction cache. Each APU may be communicatively coupled to the system bus 530 and configure to communicate with other system components, including a processing unit 502, system cache 512, RAM 511, non-volatile RAM 513, operating system 521, Network adapter 550, and Input/Output interfaces 540. In some computing environments, one or more of the APUs 503 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing devices. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus comprising:
a storage;
a memory; and
at least one processor communicatively coupled to the memory and the storage, wherein the at least one processor is configured to:
retrieve an annotated source dataset from the storage via a software application;
retrieve a non-annotated target dataset from the storage via the software application;
identify a subset of data from the annotated source dataset, wherein the subset is configured to include source dataset data that is similar to the non-annotated target dataset;
reduce the subset of data from the annotated source dataset by use of a classifier to remove redundant data from the subset of data from the annotated source dataset; and
classify data from the non-annotated target dataset using an AI model trained on the subset of the annotated dataset instead of an AI model trained on the annotated source dataset, wherein the classifying reduces computational resources of the at least one processor communicatively coupled to the storage.

2. The apparatus of claim 1, wherein the at least one processor is configured to convert the annotated source dataset and the non-annotated target dataset to a plurality of vectors, and wherein the conversion comprises execution of a Contrastive Language-Image Pre-training (CLIP) and a Vision Transformer (ViT) on data in the annotated source dataset and data in the non-annotated target dataset.

3. The apparatus of claim 1, wherein the at least one processor is configured to rank the data in the annotated source dataset for similarity with the data in the non-annotated target dataset, wherein the rank comprises execution of a CLIP Maximum Mean Discrepancy (CMMD) on CLIP and ViT vectors on the data in the annotated source dataset and the data in the non-annotated target dataset.

4. The apparatus of claim 1, wherein the at least one processor is configured to cluster the data in the annotated source dataset for similarity with the data in the non-annotated target dataset, wherein the cluster comprises a k-means clustering on CLIP and ViT vectors in the annotated source dataset and the non-annotated target dataset.

5. The apparatus of claim 1, wherein the reduction comprises at least one of a similarity graph and a distribution classifier.

6. The apparatus of claim 1, wherein the at least one processor is configured to include a distribution classifier configured to minimize divergence between the data in the reduced subset of data from the annotated source dataset and the annotated source dataset.

7. The apparatus of claim 1, wherein the at least one processor is configured to perform at least one of train the AI model or implement the trained AI model, wherein the AI model is trained with a neural network capability based on the reduced subset of data from the annotated source dataset, wherein the AI model is trained with at least one of a distribution classifier, a similarity graph, a clustered set of source images, a clustered set of target images, a similarity score for target images and source images, and a ranking of similarity scores.

8. A method comprising:
retrieving an annotated source dataset from a storage via a software application;
retrieving a non-annotated target dataset from the storage via the software application;
identifying a subset of data from the annotated source dataset, wherein the subset is configured to include source dataset data that is similar to the non-annotated target dataset;
reducing the subset of data from the annotated source dataset by using a classifier to remove redundant data from the subset of data from the annotated source dataset; and
classifying data from the non-annotated target dataset using an AI model trained on the subset of the annotated dataset instead of an AI model trained on the annotated source dataset, wherein the classifying reduces computational resources of a processor communicatively coupled to the storage.

9. The method of claim 8, comprising converting the annotated source dataset and the non-annotated target dataset to a plurality of vectors, wherein the converting comprises executing a Contrastive Language-Image Pre-training (CLIP) and a Vision Transformer (ViT) on data in the annotated source dataset and data in the non-annotated target dataset.

10. The method of claim 8, comprising ranking the data in the annotated source dataset for similarity with the data in the non-annotated target dataset, wherein the ranking comprises executing a CLIP Maximum Mean Discrepancy (CMMD) on CLIP and ViT vectors on the data in the annotated source dataset and the data in the non-annotated target dataset.

11. The method of claim 8, comprising clustering the data in the annotated source dataset for similarity with the data in the non-annotated target dataset, wherein the clustering comprises a k-means clustering on CLIP and ViT vectors in the annotated source dataset and the non-annotated target dataset.

12. The method of claim 8, wherein the reducing comprises at least one of a similarity graph and a distribution classifier.

13. The method of claim 8, comprising a distribution classifier configured to minimize divergence between the data in the reduced subset of data from the annotated source dataset and the annotated source dataset.

14. The method of claim 8, comprising performing at least one of training the AI model or implementing the trained AI model, wherein the training the AI model comprises using a neural network capability based on the reduced subset of data from the annotated source dataset, wherein the training includes at least one of a distribution classifier, a similarity graph, a clustered set of source images, a clustered set of target images, a similarity score for target images and source images, and a ranking of similarity scores.

15. A computer readable storage medium comprising instructions, that when read by a processor, cause the processor to perform:
retrieving an annotated source dataset from a storage via a software application;
retrieving a non-annotated target dataset from the storage via the software application;
identifying a subset of data from the annotated source dataset, wherein the subset is configured to include source dataset data that is similar to the non-annotated target dataset;
reducing the subset of data from the annotated source dataset by using a classifier to remove redundant data from the subset of data from the annotated source dataset; and
classifying data from the non-annotated target dataset using an AI model trained on the subset of the annotated dataset instead of an AI model trained on the annotated source dataset, wherein the classifying reduces computational resources of the processor communicatively coupled to the storage.

16. The computer readable storage medium of claim 15, wherein the processor is configured to perform converting the annotated source dataset and the non-annotated target dataset to a plurality of vectors, wherein the converting comprises executing a Contrastive Language-Image Pre-training (CLIP) and a Vision Transformer (ViT) on data in the annotated source dataset and data in the non-annotated target dataset.

17. The computer readable storage medium of claim 15, wherein the processor is configured to perform ranking the data in the annotated source dataset for similarity with the data in the non-annotated target dataset, wherein the ranking comprises executing a CLIP Maximum Mean Discrepancy (CMMD) on CLIP and ViT vectors on the data in the annotated source dataset and the data in the non-annotated target dataset.

18. The computer readable storage medium of claim 15, wherein the processor is configured to perform clustering the data in the annotated source dataset for similarity with the data in the non-annotated target dataset, wherein the clustering comprises a k-means clustering on CLIP and ViT vectors in the annotated source dataset and the non-annotated target dataset.

19. The computer readable storage medium of claim 15, wherein the reducing comprises at least one of a similarity graph and a distribution classifier.

20. The computer readable storage medium of claim 15, wherein the processor is configured to perform at least one of training the AI model or implementing the trained AI model, wherein the training the AI model comprises using a neural network capability based on the reduced subset of data from the annotated source dataset, wherein the training includes at least one of a distribution classifier, a similarity graph, a clustered set of source images, a clustered set of target images, a similarity score for target images and source images, and a ranking of similarity scores.
